(19) United States
(12) Patent Application Publication
(10) Pub. No.: US 2021/0129348 A1
(43) Pub. Date: May 6, 2021

(54) CAMERA MONITORING METHOD

(71) Applicant: ABB Schweiz AG, Baden (CH)

(72) Inventors: Matt Simkins, Redwood City, CA (US); Said Zahrai, Graefelfing (DE)

(21) Appl. No.: 17/146,504

(22) Filed: Jan. 12, 2021

Related U.S. Application Data
(63) Continuation of application No. PCT/EP2018/069057, filed on Jul. 13, 2018.

(51) Int. Cl. B25J 13/08; B25J 9/16; B25J 19/02

(52) U.S. Cl. CPC B25J 13/088; B25J 19/023; B25J 9/1664; B25J 9/1697

(57) ABSTRACT

A method for monitoring operation of at least one camera observing a scenery includes the steps of: a) producing (S1) a moving pattern within a field of view of the camera; b) detecting a change (S2) in successive images from the camera; and c) determining (S4) that the camera is not in order if no change is detected.

### CROSS-REFERENCE TO PRIOR APPLICATION

This application is a continuation of International Patent Application No. PCT/EP2018/069057, filed on Jul. 13, 2018, the entire disclosure of which is hereby incorporated by reference herein.

### FIELD

The present invention relates to a method for monitoring operation of a camera.

### BACKGROUND

In an industrial environment where a robot is operating, it is necessary to ensure that no person can get within the operating range of the robot and be injured by its movements. To that effect, cameras can be employed to watch the surroundings of the robot. However, safety for persons can only be ensured based on the images provided by these cameras if it can be reliably decided whether these images are representative of the current state of the surroundings.

### SUMMARY

In an embodiment, the present invention provides a method for monitoring operation of at least one camera observing a scenery, comprising the steps of: a) producing (S1) a moving pattern within a field of view of the camera; b) detecting a change (S2) in successive images from the camera; and c) determining (S4) that the camera is not in order if no change is detected.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic diagram of a setup according to a first embodiment of the invention and.

FIG. 2 is a schematic diagram of a setup according to a second embodiment of the invention; and

FIG. 3 shows flowcharts of methods of the invention.

### DETAILED DESCRIPTION

In an embodiment, the present invention provides a simple method for monitoring the operation of a camera, on which such a decision can be based.

In an embodiment, the present invention provides a method for monitoring operation of at least one camera observing a scenery, comprising the steps of

a) producing a moving pattern within the field of view of the camera

b) detecting a change in successive images from the camera; and

c) determining that the camera is not in order if no change is detected.

If the field of view of the camera covers the moving robot, movements of the robot may also cause a change in successive images from the camera, so if the movement of the robot is discerned in the images, it may be assumed that the camera is in order and is producing real-time images. However, if the robot is standing still, there is no basis for such an assumption. In that case, therefore, the robot mustn't start moving, unless it can be ensured in some other way that the camera is working properly. This can be done by first moving the pattern, since the pattern may be moved without endangering a person.

A more reliable judgment of the condition if the camera can be based on estimating a speed of the pattern based on images from the camera and determining that the camera is not in order if the estimated speed differs significantly from the real speed of the moving pattern. In that way it is possible to tell apart a real-time image series from e.g. images repeated in an endless loop.

Further, delays in transmission of images from the camera can be detected based on a delay between a change of speed of the moving pattern and a subsequent change of the estimated speed. Knowledge of such a delay can be useful for setting a minimum distance below which the distance between the robot and a person cannot be allowed to fall without triggering an emergency stop or at least a decrease of the maximum allowable speed of the robot.

The pattern can be generated by projecting it onto the scenery, provided that the scenery comprises a surface on which the pattern can be projected; in that case by focusing the camera on the surface, it can be ensured that a focused image of the pattern is obtained.

If it isn't certain that the scenery comprises a surface on which to project the pattern, then the pattern can be embodied in a physical object which is placed within the field of view of the camera. The pattern can then be moved by displacing the object.

Alternatively, the object can be an LCD screen interposed between the camera and the scenery; in that case the LCD screen doesn't have to be displaced in order to produce a moving pattern; instead the pattern may be formed by pixels of the LCD screen which are controlled to have different colours or different degrees of transparency, and the pattern is made to move by displacing these pixels over the LCD screen.

In a camera system comprising at least a pair of cameras, whose fields of view overlap at least partially, such as a 3D vision system, the moving pattern can be located in the overlapping part of the fields of view. So a single moving pattern is sufficient for monitoring the operation of plural cameras.

The moving pattern can be implemented in one physical object which is moving within the fields of view of the cameras. In that case, the fields of view of the cameras do not even have to overlap; rather, due to the movement of the physical object, a pattern formed by part of it may appear successively in the fields of view of the cameras.

If there are multiple cameras, the reliability of a decision whether a camera is in order or not can be improved by generating a first estimate of the speed of the pattern based on images from one of the cameras, generating a second estimate of the speed of the pattern based on images from another one of the cameras and determining that at least one camera is not in order if the speed estimates speed differ significantly, i.e. if they differ more than would be expected given the limited accuracy of the first and second estimates.

If there are at least three cameras, at least three speed estimates can be generated based on images from these cameras. Here at least two of the cameras are determined to be in order if the speed estimates derived from these cameras do not differ significantly, i.e. while according to other embodiments only the judgment that a camera is not in order is certain, and the camera may still be defective in some way or other even if is not judged not to be in order, this embodiment allows a positive judgment that a camera is in order and can be relied upon.

According to a preferred application of the invention, the scenery which is monitored by the camera or cameras comprises at least one robot, and movement of the robot is inhibited if it is determined that a camera is not in order or movement of the robot is controlled taking into account images from cameras determined to be in order only.

Further features and advantages of the invention will become apparent from the following description of embodiments thereof, referring to the appended drawings.

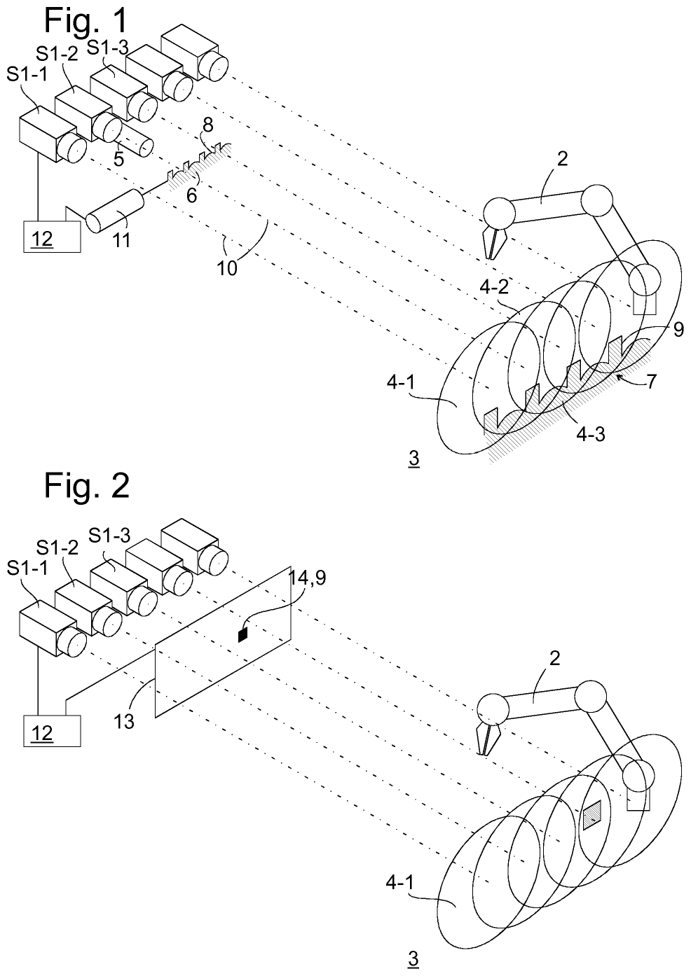

In FIG. 1, a plurality of cameras 1-1, 1-2, . . . is provided for monitoring the environment of a robot 2. The cameras 1-1, 1-2, . . . face a surface confining the environment, e.g. a wall 3. The cameras 1-1, 1-2, . . . have overlapping fields of view 4-1, 4,2, . . . , symbolized in FIG. 1 by circles on wall 3.

A projector projects an image 7 of an object 6 onto wall 3. FIG. 1 only shows a light source 5 of the projector; there may be imaging optics between the object 6 and the wall 3.

The object 6 shields part of the wall 3 from light of the light source 5. An edge 8 of the object 6, which is projected onto the wall 3, produces a outline pattern 9 which extends through the fields of view 4-1, 4,2, . . . of the cameras.

The object 6 is displaced in a direction perpendicular to optical axes 10 of the cameras 1-1, 1-2, . . . by a motor 11. A controller 12 is connected to receive image data from the cameras 1, 1-2, . . . , to control the motor 11 and to provide camera status data to the robot 2.

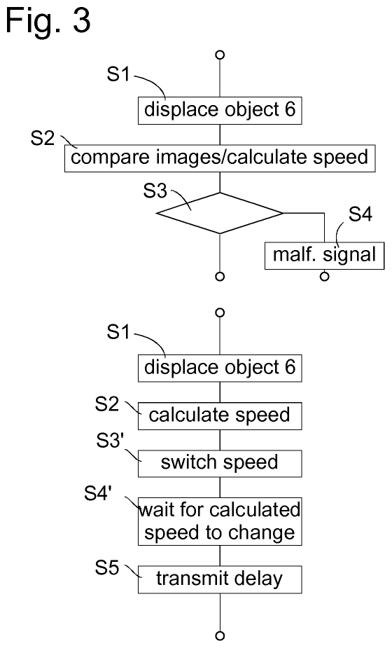

According to a first embodiment of the invention, the motor 11 is controlled to displace the object 6 continuously (cf. step s1 of FIG. 3). If the object 6 is e.g. an endless band or a rotating disk, it can be displaced indefinitely without ever having to change its direction. The outline 9 thus moves continuously through the field of view 4-1, 4-2, . . . of each camera.

In this embodiment the controller 12 can monitor each camera 1-1, 1-2, . . . independently from the others by comparing (S2) pairs of successive images from each camera. If in step S3 the amount of pixels whose colour is changed from one image to the next exceeds a given threshold, then it can be assumed that the camera produces live images, and the method ends. If the amount is less than the threshold, then it must be concluded that the moving outline 9 cannot be represented in the images, and in that case the camera is not operating correctly. In that case a malfunction signal is output (S4) to the robot 2, indicating that a person in the vicinity of the robot 2 might go undetected by the cameras. The robot 2 responds to the malfunction signal by stopping its movement.

In a somewhat more sophisticated approach, the controller 12 calculates, based on the speed at which the object 6 is displaced by motor 11 in step S1, the speed at which an image of edge 8 should be moving in consecutive images from the camera (S2), and if it finds in the images a structure which is moving at this speed (S3), then it concludes that the outline 9 is the image of edge 8, and that, since the outline 9 is correctly perceived, the camera seems to operate correctly. If there is a moving structure, but its speed and/or its direction of displacement doesn't fit edge 8, then the camera isn't operating correctly, and the malfunction signal is output to the robot 2 (S4).

According to still another approach, the controller 12 is programmed to switch from a first speed to a second speed of object 6 at a predetermined instant (step S3′). If the images from the camera comprise a pattern corresponding to edge 8, the controller 12 will continue to receive images in which this pattern moves at the first speed for some time after said instant, due to a non-vanishing delay in transmission of the images to the controller 12. This delay detected (S5) and is transmitted to the robot 2. If the delay exceeds a predetermined threshold, the robot 2 stops, just as in case it receives the malfunction signal mentioned above, because even if a person approaching the robot 2 could be identified in the images, this would happen so late that the person cannot be protected from injury by the robot unless the robot 2 is stopped completely. Below the threshold, the distance to which a person may approach the robot 2 before the robot stops to move can be set the higher, the smaller the delay is.

The setup of FIG. 1 requires the existence of the wall 3 or some other kind of screen on which the pattern 9 can be projected. If there is no such screen available in the environment of the robot 2, e.g. because the robot 2 is working in a large hall whose walls are far away from the robot, or because the environment contains unpredictably moving objects, then the object 6 itself is placed within the fields of view of the cameras 1-1, 1-2, . . . , and the projector can be dispensed with.

The physical object 6 and the motor 11 for displacing it can be replaced by an LCD screen 13 as shown schematically in FIG. 2, pixels of which can be controlled to be transparent, or to form a moving opaque region 14 by controller 12. Like the physical object 6, the LCD screen 13 can be part of a projector, so that a shadow of the opaque region is projected into the scenery as the moving pattern 9, or the LCD screen 13 can be placed in front of the cameras 1-1, 1-2, . . . , so that the opaque region 14 of the LCD screen 13 itself is the moving pattern 9 which is to be detected by the cameras 1-1, 1-2, . . . . The above-described methods can be carried out separately for each camera 1-1, 1-2, . . . . However, since all cameras 1-1, 1-2, . . . are watching the same object 6, advantage can be drawn from the fact that if the cameras 1-1, 1-2, . . . are working properly, an estimation of the speed of object 6 should yield the same result for all cameras. If it doesn't, at least one camera isn't operating properly.

In such a case, different ways of proceeding are conceivable. If speed estimates disagree and there is no way to find out which estimate can be relied upon and which not, then it must be concluded that no camera can be trusted to provide correct images; in that case controller 12 outputs the malfunction signal to robot 2, and robot 2 stops moving.

There are various ways to find out which camera can be trusted and which not. E.g. if the controller 12 also controls the movement of object 6 and is therefore capable of calculating an expected speed of the object 6 which should also be the result of the camera-based estimates, then any camera whose images yield a speed estimate of object 6 which differs significantly from the expected speed can be determined as not operating properly.

Alternatively, if there are at least three cameras and at least two of these yield identical speed estimates, then it can be concluded that these cameras are working properly, and that a camera that yields a deviating estimate is not.

If part of the field of view of camera which was found to not to operate properly is not monitored by other cameras, there is a possibility that a person who approaches robot 2 in this part of the field of view goes unnoticed. In order to prevent this from happening, controller 12 can output the malfunction signal to robot 2, causing it to stop moving, as described above. If the field of view of the improperly operating camera has no part which is not monitored by a second camera, it is impossible for a person to approach robot 2 without being detected; in that case the robot 2 can continue to operate, but a warning should be output in order to ensure that the improperly operating camera will undergo maintenance in the near future.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 camera
2 robot
3 wall
4 field of view
5 light source
6 object
7 image
8 edge
9 pattern
10 optical axis
11 motor
12 controller
13 LCD screen
14 opaque region

What is claimed is:

1. A method for monitoring operation of at least one camera observing a scenery, comprising the steps of:
a) producing (S1) a moving pattern within a field of view of the camera;
b) detecting a change (S2) in successive images from the camera; and
c) determining (S4) that the camera is not in order if no change is detected.

2. The method of claim 1, further comprising the steps of estimating (S3) a speed of the moving pattern based on images from the camera as an estimated speed and determining that the camera is not in order if the estimated speed differs from a real speed of the moving pattern.

3. The method of claim 2, further comprising the steps of changing (S3′) the speed of the moving pattern to provide a change of speed and detecting a delay (S4′) between the change of speed of the moving pattern and a change of the estimated speed.

4. The method of claim 1, wherein the moving pattern is generated by projecting the moving pattern onto the scenery.

5. The method of claim 1, wherein the moving pattern is generated by displaying the moving pattern on an LCD screen interposed between the camera and the scenery.

6. The method of claim 1, wherein the method is used for monitoring operation of at least a pair of cameras, and
wherein fields of view of the cameras overlap at least partially in an overlapping part and the moving pattern is located in the overlapping part.

7. The method of claim 1, wherein the method is used for monitoring operation of at least a pair of cameras, and
wherein the moving pattern is implemented in one physical object which is moving within the fields of view of the cameras.

8. The method of claim 6, further comprising the steps of generating a first estimate of the speed of the moving pattern based on images from one of the cameras and generating a second estimate of the speed of the moving pattern based on images from another one of the cameras and determining that at least one camera is not in order if the first estimate and second estimate differ.

9. The method of claim 8, wherein the at least a pair of cameras comprises first, second, and third cameras, and
wherein at least three speed estimates are generated based on images from first, second, and third cameras, and at least two of the cameras are determined to be in order if the speed estimates derived from those cameras do not differ.

10. The method of claim 1, wherein the scenery comprises at least one robot, and movement of the robot is inhibited (S4) if it is determined that a camera is not in order or movement of the robot is controlled taking into account only images from cameras determined to be in order.
